(19) United States
(12) Patent Application Publication
(10) Pub. No.: US 2013/0060531 A1
(43) Pub. Date: Mar. 7, 2013

(54) DYNAMIC TAGGING TO CREATE LOGICAL MODELS AND OPTIMIZE CACHING IN ENERGYMANAGEMENT SYSTEMS

(71) Applicants: Robert Burke, Dallas, TX (US); Brian Reinhart, Addison, TX (US)

(72) Inventors: Robert Burke, Dallas, TX (US); Brian Reinhart, Addison, TX (US)

(73) Assignee: HUNT ENERGY IQ, L..P., Dallas, TX (US)

(21) Appl. No.: 13/465,345

(22) Filed: May 7, 2012

Related U.S. Application Data
(60) Provisional application No. 61/530,665, filed on Sep. 2, 2011.

(51) Int. Cl. G06F 17/50

(52) U.S. Cl. 703/1

(57) ABSTRACT

A system, computer-implemented method, and a computer program product are provided for dynamic tagging to create logical models and optimize caching in energy management systems. A set of variables is aggregated for a first facility in response to first selections via the user interface. A set of variables for a second facility is aggregated in response to second selections via the user interface. The number of the set of variables for the first facility differs from the number of the set of variables for the second facility. The aggregation for the first facility is output as part of a first facility model via the user interface. The aggregation for the first facility is identified by a tag. The aggregation for the second facility is output as part of a second facility model via the user interface. The aggregation for the second facility is identified by the tag.

### CROSS REFERENCE TO RELATED APPLICATIONS

This application is a non-provisional application claiming priority to the U.S. Provisional Application, Ser. No. 61/530,665 to Burke, filed Sep. 2, 2011, and which is incorporated herein by reference for all purposes.

### FIELD OF THE PRESENT DISCLOSURE

The invention relates generally to energy management, and more specifically to a system, computer-implemented method, and computer program product for dynamic tagging to create logical models and optimize caching in energy management systems.

### BACKGROUND

Often a manual process is used to configure a physical infrastructure's data within an energy management system. The physical infrastructure's data is then mapped to a static model that may include a very limited, fixed set of collections or categories, such as HVAC, refrigeration, etc. The static model and the physical infrastructure's configuration are often presented directly to the users as a monolithic, static views of the Energy Management System's data. Generally, a Facility Domain Expert is the primary stakeholder of the Energy Management System because of the technical nature of the Energy Management System's data. An Energy Domain Expert can often make use of the Energy Management System, but a Business Domain Expert is often poorly, if at all, served.

The configuration and depiction of large quantities of Equipment presents some operational challenges for Energy Management Systems. How the Equipment is depicted within an Energy Management System can be significantly impacted by the subtle differences of the physical deployments from facility to facility. For example, a large retail facility may use five meters to accurately capture its HVAC totals, while a smaller building may use only two meters to accurately capture its HVAC totals. Furthermore, for purely electrical and wiring reasons there may be various Equipment and meters that need to be installed which provide no real value within an Energy Management System, such as transformer meters. Reviewing these subtle variations between facilities can confuse Energy Management System users who are less familiar with physical facilities. Furthermore, these variations between facilities can create problems with the back-end data processing layer that needs to be programmed to handle all the various physical permutations.

The support of different Domain Experts within a common platform may create problems because Facility Domain Experts, Energy Domain Experts, and Business Domain Experts view the Energy Management System from different perspectives. These divergent perspectives are realized in the different Performance Indicators that each Domain Expert typically tracks. For example, a Facility Domain Expert may be interested only in the real-time data from Equipment, the Energy Domain Expert may be interested only in the aggregate energy costs for each of multiple facilities, and a Business Domain Expert may only be interested in the quarter to quarter reduction in energy cost for all facilities in a national region.

As the amount of data stored in an Energy Management System increases, the overall performance of the Energy Management System slows. More advanced Energy Management Systems may attempt to address this slowing performance problem by providing a static set of data that is pre-calculated at fixed frequencies. Unfortunately, even when all of the pre-calculated data may not be relevant to the various Domain Experts, the data is still pre-calculated anyway.

Increasing demand will be placed on these Energy Management Systems to provide support for more equipment, collect larger quantities of data, and provide interfaces to increasingly diverse sets of Domain Experts. These Energy Management Systems face serious data management related problems, such as how to configure and depict large quantities of Equipment, how to support data views tailored to a heterogeneous set of domain experts, and how to process and view increasing quantities of data.

### SUMMARY

A system, computer-implemented method, and computer program product are provided for dynamic tagging to create logical models and optimize caching in energy management systems. The system enables a user to select aggregations of differing numbers of variables for different facilities, and identify these aggregations with the same “tags.” When a user interface outputs logical models of the different facilities, the same tags identify the user-selected aggregates, regardless of the number of underlying variables. For example, a user selects to aggregate the five meters used to capture the HVAC totals for a large retail facility, selects to aggregate the two meters to capture the HVAC totals for a smaller building, and identifies these aggregations with the tag “HVAC.” The user interface outputs the logical models for the two facilities, which include “HVAC” tags that depict the HVAC totals for the corresponding facilities while hiding the physical variations that exist between the facilities. The logical models may then be used to calculate Performance Indicators seamlessly across any number of physically heterogeneous facilities.

The system also enables a user to aggregate the same variable to different tags. For example, the user selects to aggregate the five meters used to capture the HVAC totals for a large retail facility, and selects to aggregate all meters in a city, including the five meters in the large retail facility, to capture the HVAC totals for all buildings in the city. The user interface outputs the logical model for the facility and the logical model for the city, which include a “facility HVAC” tag that depicts the HVAC totals for the large retail facility, for the Facility Domain Expert, and a “city HVAC” tag that depicts the HVAC totals for all of the facilities in the city, for the Energy Domain Expert, while hiding the physical variations that exist between the facility and all of the facilities in the city.

The system stores the user-selected aggregations as subscriptions in a logical model library. The system performs periodic calculations by identifying the model subscriptions in the logical model library and only aggregates the variables identified by the model subscriptions. The system separates the core calculation code from the complex, and somewhat arbitrary nature of the physical model, and limits its calculations to the tags for the dynamically created logical models. The system pre-calculates these user-selected aggregations and caches the calculated results to provide faster response time when the user interface subsequently requests the output of a logical model that requires these aggregations.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure;

FIG. 2 presents a sample frame depicted by a user interface of the present disclosure;

FIG. 3 presents another sample frame depicted by a user interface of the present disclosure; and

FIG. 4 presents a sample method of the present disclosure.

### DEFINITIONS

As used herein, Facility Domain refers to the one or more facilities, buildings, plants, operations platforms, etc., consuming energy, and the power uses within such facilities, and expertise specifically related to such facilities, such as knowledge regarding building management, physical assets, power use, energy power consumption devices, and monitoring tools. A customer will have personnel, whether employees or contractors, with expertise in the Facility Domain, and capable of defining or identifying facility Performance Indicators, referred to as a facility manager.

As used herein, Energy Domain refers to energy consumption, use, distribution of use, energy consumption behavior, energy measurement, energy use measurement, key Performance Indicators for a business sector, etc., and the knowledge and expertise specific to such information. An Energy Domain Analyst, or simply “analyst,” is a person, whether employed by a customer, or contracted as an expert, with expertise in the Energy Domain and capable of defining or identifying energy use Performance Indicators.

As used herein, Business Domain refers to business or customer operations, revenue, revenue targets, budgeting, planning, costs, cost goals, etc., and the knowledge and expertise relevant to a business. A customer will have personnel, whether employees or contractors, who are experts in the Business Domain capable of defining or identifying business Performance Indicators. Energy Resource Management, as used herein, refers to management of energy consumption and its by-products at the Business Domain level. It is to be understood that various experts and analysts referred to herein may be one or more person, an employee or contractor, and that a single person may qualify as an expert in more than one Domain.

As used herein, Equipment refers to one or more energy consuming devices, such as Heating, Ventilation, and Air Conditioning (HVAC) systems, water pumps, compressors, engines, lighting systems, etc. The term Equipment may mean a single piece of equipment or a logical grouping of several pieces of equipment. For example, Equipment may refer to a group of electrical devices in a single location, such as on a floor of a facility or at a machine bay or on a rig. Similarly, Equipment may be grouped by type of device, such as all the HVAC units for a facility.

As used herein, Business Intelligence refers to software-based tools used to extract, create, and/or import key Performance Indicators for a customer. As used herein, Performance Indicators refer to data and/or variables regarding energy consumption, energy resource management, costs, usage, etc. that can be used to generate insights into energy use and efficiency. Performance Indicators refer to information that may be used in creating, modifying, describing and displaying load profiles. For example, a facility Performance Indicator may be a facility's HVAC load profile, which combines the facility's energy demand measured by meter 1 for HVAC unit 1 and the facility's energy demand measured by meter 2 for HVAC unit 2.

As used herein, Domain Variables refer to the data and the variables (such as kilowatts, kilowatt hours, etc.) for all of the various domains, such as the Facility Domain, the Energy Domain, and the Business Domain. As used herein, Domain Mapping refers to the translation of Performance Indicators from one domain to a set of Performance Indicators in another domain. For example, a business Performance Indicator may be a number of sales per kilowatt hour, and an energy Performance Indicator may be the demand cost for the collective lighting systems across ten buildings, while a facility Performance Indicator may be the average temperature during a period of sales.

### DETAILED DESCRIPTION OF SOME EMBODIMENTS

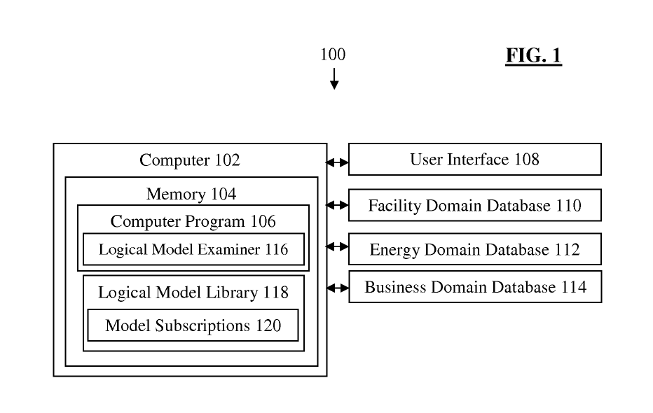

FIG. 1 presents a sample system 100 of the present disclosure, which may also be referred to as an energy management system 100. The system 100 includes a computer 102, a memory 104, a computer program 106, and a user interface 108. The computer program 106 is stored in the memory 104 and executed by the computer 102 to communicate via the user interface 108 with system users.

The computer 102 also communicates with a Facility Domain database 110, an Energy Domain database 112, and a Business Domain database 114, which may be mutually exclusive databases. The computer program 106 includes a logical model examiner 116. The computer 102 also communicates with a logical model library 118, which includes model subscriptions 120. Although FIG. 1 depicts one of each of the elements 102-120, the system 100 may include any number of each of the elements 102-120.

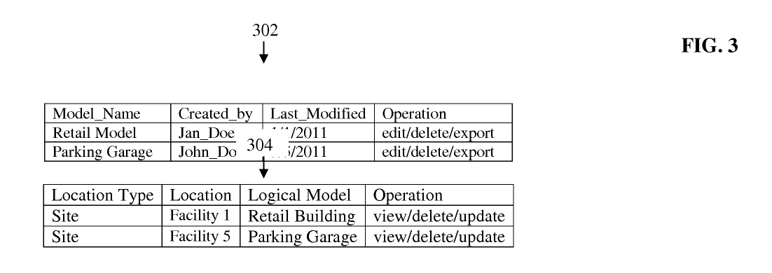

The logical model examiner 116 enables a user to select aggregations of variables for different facilities, and identify the aggregations for each facility by tags. The logical model library 118 stores logical models and model subscriptions 122 accessed by the system 100. An example of the logical model library 118 and the model subscriptions 120 are described below in reference to FIG. 3.

Examples of data in the Business Domain include budgets, corporate energy conservation goals, sales transactions, operational expenses, energy cost, demand cost, and transaction and energy cost. Examples of data in the Energy Domain, upon which data in the Business Domain may be based, include calculated data such as real usage, reactive usage, power factor, maximum demand, kilovolt-ampere reactive (kVAr), kilovolt-ampere reactive hours (kVArh), power factor, kilowatts during a base time of use, kilowatts during an intermediate time of use, kilowatts during a sub-peak time of use, kilowatts during a peak time of use, kilowatt hours during a base time of use, kilowatt hours during an intermediate time of use, kilowatt-hours during a sub-peak time of use, and kilowatt hours during a peak time of use. Examples of data in the Facility Domain, upon which the data in the Energy Domain may be based, include raw data such as meter data, meter configuration, metered data, a sampling frequency, heating ventilation and air conditioning (HVAC) data, lighting data, humidity and, temperature.

The computer program 106 enables a user to select aggregation of differing numbers of variables for different facilities, and identify these aggregations with the same “tags.” When the user interface 108 outputs logical models of the different facilities, the same tags identify the user-selected aggregates, regardless of the number of underlying variables. For example, the user selects to aggregate the five meters used to capture the HVAC totals for a large retail facility or selects to aggregate the two meters to capture the HVAC totals for a smaller building, and identifies these aggregations with the tag “HVAC.” The user interface 108 outputs the logical models for the two facilities, which include “HVAC” tags that depict the HVAC totals for the corresponding facilities, while hiding the physical variations that exist between the facilities. The logical models may then be used to calculate Performance Indicators seamlessly across any number of physically heterogeneous facilities. This mapping of dynamic tags confines the often complex and esoteric process of wiring and configuring meters within a facility to the lowest layers of the system 100. All operations and views of data may then be based on logical, consistent models. This dynamic tagging greatly simplifies the algorithms that run within the system 100 by hiding the physical variations.

The computer program 106 also enables a user to aggregate the same variable to different tags. For example, the user selects to aggregate the five meters used to capture the HVAC totals for a large retail facility and selects to aggregate all meters in a city, including the five meters in the large retail facility, to capture the HVAC totals for all buildings in the city. The user interface 108 outputs the logical models, which include a “facility HVAC” tag that depicts the HVAC totals for the large retail facility, for the Facility Domain Expert, and a “city HVAC” tag that depicts the HVAC totals for all of the facilities in the city, for the Energy Domain Expert, while hiding the physical variations that exist between the facility and all of the facilities in the city. These logical models may be personalized by each user, so that each user may have a completely different view of the Energy Management System's data. For example, a Business Domain Expert may create a logical model of all the lighting costs for the chemistry buildings on a three campuses, essentially creating a “virtual campus,” thereby enabling the tracking of these costs. Once a user no longer needs a view that the user created of the data, the user may simply delete the corresponding logical model.

The computer program 106 stores the user-selected aggregations as model subscriptions 120 in the logical model library 118. The computer program 106 performs periodic calculations by identifying the model subscriptions 120 in the logical model library 118 and only aggregating the variables identified by the tags in the model subscriptions 120. The computer program 106 separates the core calculation code from the complex, and somewhat arbitrary nature of the physical model, and limits its calculations to the tags for the dynamically created logical models. The computer program 106 pre-calculates these user-selected aggregations and caches the calculated results to provide faster response time when the user interface 108 subsequently requests the output of a logical model that requires these aggregations.

The computer program 106 enables end-users to dynamically sort energy data and create custom views of Energy Management System data, which also simplifies the calculation of Performance Indicators. The computer program 106 improves the performance of large Energy Management System databases by enabling each user to configure the aggregates of interest.

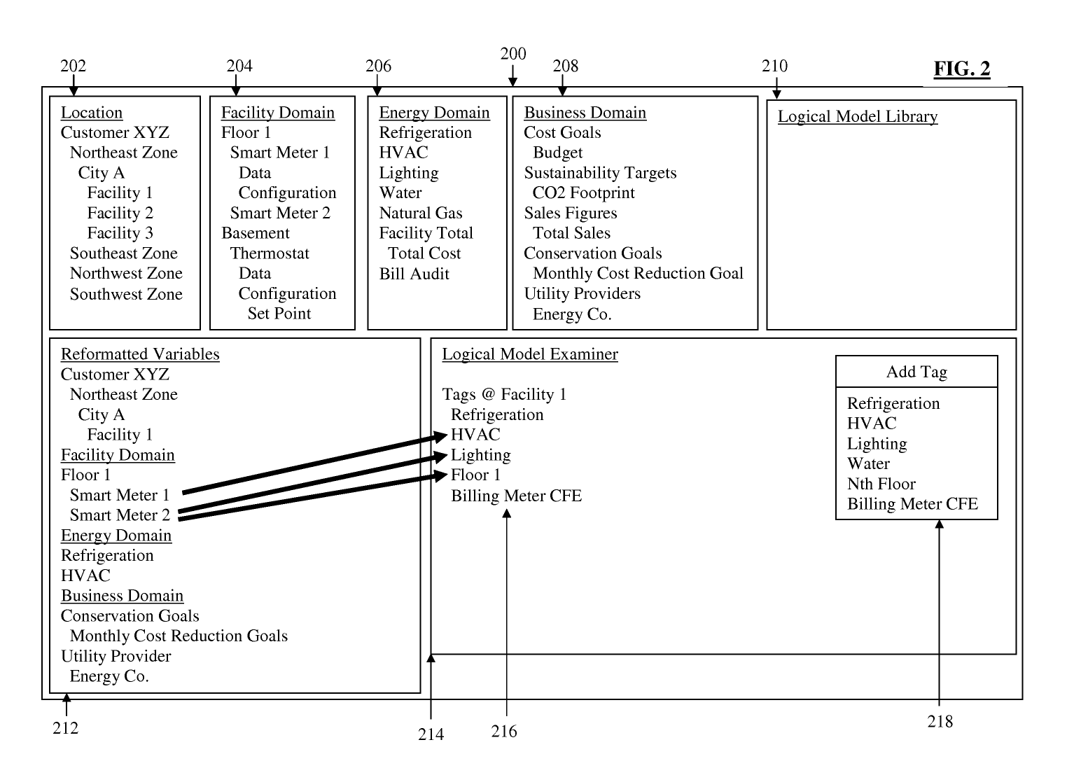

FIG. 2 presents a sample frame 200 presented by the user interface 108 in FIG. 1 of the present disclosure. The frame 200 includes a location column 202, a facility domain column 204, an energy domain column 206, a business domain column 208, a logical model library column 210, a reformatted variables column 212, and a logical model examiner column 214.

The location column 202 includes a row for customer XYZ, which includes indented rows for a northeast zone, a southeast zone, a northwest zone, and a southwest zone. If the indented row for the northeast zone is selected via the user interface 108, the location column 202 depicts a double indented row for the city A. If the double indented row for the city A is selected via the user interface 108, the location column 202 depicts triple indented rows for facility 1, facility 2, and facility 3. If the triple indented row for facility 1 is selected via the user interface 108, the computer program 106 receives this selection of the facility 1 location. Subsequent selections of variable identifiers may be based on the location selection. For example, the computer program 106 receives the selection of the triple indented row for facility 1 in the location column 202, presents variables that correspond to facility 1 in city A in the northeast zone for selection in the columns 204-208, and identifies this location selection in the reformatted variables column 212.

The Facility Domain column 204 includes rows for floor 1 and basement, which correspond to facility 1 selected from the location column 202. If the row for floor 1 was selected via the user interface 108, the Facility Domain column 204 may depict indented rows for smart meter 1 and smart meter 2. If the indented row for smart meter 1 was selected via the user interface 108, the Facility Domain column 204 may depict double indented rows for data and configuration. If the row for the basement of facility 1 is selected via the user interface 108, the Facility Domain column 204 may depict a double indented row for a thermostat. If the double indented row for the thermostat of facility 1 was selected via the user interface 108, the Facility Domain column 204 may depict triple indented row for data and configuration of the thermostat. If the triple indented row for the configuration of the thermostat was selected via the user interface 108, the Facility Domain column 204 may depict a quadruple indented row for the set point of the thermostat. In this example, since the computer program 106 receives the selections of the indented rows for the smart meters in the Facility Domain column 204, the computer program 106 identifies these selections in the reformatted variables column 212.

The Energy Domain column 206 includes rows for refrigeration, HVAC, lighting, water, natural gas, facility total, and bill audit. If the row for facility total is selected via the user interface 108, the Energy Domain column 206 depicts an indented row for total cost. In this example, since the computer program 106 receives the selections of the rows for refrigeration and HVAC in the Energy Domain column 206, the computer program 106 identifies these selections in the reformatted variables column 212.

The Business Domain column 208 includes rows for cost goals, sustainability targets, sales figures, conservation goals, and utility providers. If the row for sustainability targets was selected via the user interface 108, the Business Domain column 208 may depict an indented row for CO2 footprint. If the row for sales figures was selected via the user interface 108, the Business Domain column 208 may depict an indented row for total sales. If the row for cost goals is selected via the user interface 108, the Business Domain column 208 may depict an indented row for budget. If the row for conservation goals is selected via the user interface 108, the Business Domain column 208 may depict an indented row for monthly cost reduction goal. If the row for utility providers is selected via the user interface 108, the Business Domain column 208 may depict an indented row for Energy Co. In this example, since the computer program 106 receives the selections of the indented row for monthly cost reduction goal and Energy Co. in the Business Domain column 208, the computer program 106 identifies this selection in the reformatted variables column 212.

The logical model library column 210 depicts logical models that a user may select via the user interface 108, which may serve as an alternative to the user creating a new logical model. An example of the logical model library 120 is described below in reference to FIG. 3.

The reformatted variables column 212 includes references to previous selections. For example, the reformatted variables column 212 depicts the selection of facility 1 in city A in the northeast zone for customer XYZ as the location selection, the smart meters 1 and 2 on floor 1 of facility 1 as the variables selected from the Facility Domain, the cost of the refrigeration system and the cost of the HVA system for facility 1 as the variables selected from the Energy Domain, and the monthly conservation goal and the utility provider information for Energy Co. as the variables selected from the Business Domain.

The logical model examiner column 214 may include user-selected tags 216 for the aggregation of variables. The logical model examiner column 214 may also include a prompt 218 that lists possible tags for the user to select for the aggregation of variables.

The logical model examiner column 214 enables each user to create a logical model that contains aggregations of physical Equipment arranged in more meaningful ways for each of the various Domain Experts. The user can add tags to a logical model very quickly by selecting and then associating physical Equipment with each added tag in any number of arrangements. For example, reformatted variable “Smart Meter 1” is associated with the tag “HVAC,” while the reformatted variable “Smart Meter 2” is associated with both the tag “Lighting” and the tag “Floor 1.” Furthermore, the reformatted variables “Smart Meter 1” and “Smart Meter 2” may be both tagged with the name of the facility automatically, which may assist a user in differentiating between these smart meters and smart meters in another facility. Finally, the tags themselves may be associated with each other to form a dependency tree. For example, a user may select to aggregate both the “HVAC” tag and the “Lighting” tag as an aggregation that is mapped to the “Billing Meter CFE” tag.

Once a user has selected to aggregate variables and identified these aggregations with tags for a logical model, the user may save the logical model's collections of tags to the logical model library 118 for later use. For example, the computer program 106 may enable a user to save the tags representing aggregations for facility 1's refrigeration, HVAC, lighting, floor 1, and billing meter CFW as tags for facility 1's logical model in the logical model library 118.

The computer program 106 may subsequently access the tags from the logical model library 118 when determining which calculations to conduct on a periodic basis. For example, the computer program 106 accesses the tags representing aggregations for facility 1's refrigeration, HVAC, lighting, floor 1, and billing meter CFW from the logical model library 118, pre-calculates these aggregations, and caches the results to provide faster response time when the user interface 108 subsequently requests the output of the logical model for facility 1, which requires these aggregations.

The frame 200 may be part of a larger display screen that includes fields for users to enter commands to make, edit, and store selections and transform text. The user interface 108 in FIG. 1 may output a display screen that includes the frame 200 in FIG. 2 in response to a search based on search criteria input via the user interface 108 in FIG. 1. For example, a system user may enter search criteria to request to review the frame 200, which corresponds to the selections and text previously entered.

FIG. 3 presents a sample frame 300 presented by the user interface 108 in FIG. 1 of the present disclosure. The frame 300 includes a logical model library 302 and model subscriptions 304. A system user may instruct the computer program 106 to import tags from the model subscriptions 304 for the logical models in the logical model library 302 into the logical model examiner column 214 in FIG. 2.

The logical model library 302 includes rows and columns such as a “model name” column, a “created by” column, a “last modified” column, and an “operation” column. For example, after the first row in the logical model library 302 that includes the headings for these columns, the “model names” column specifies a name assigned by a system user to each set of tagged variables for a logical model, a “created by” column specifies a system user who created each logical model, and the “last modified” column specifies when each logical model was modified. By selecting from the corresponding options of edit, delete, and export in the “operation” column, a system user instructs the computer program 106 to edit the corresponding logical model, to delete the corresponding logical model, or to export the corresponding logical model.

The model subscriptions 304 include rows and columns such as a “location type name” column, a “location” column, a “logical model” column, and an “operation” column. For example, after the first row in the model subscriptions 304 that includes the headings for these columns, the “location type” column specifies whether the location for a logical model is a site, a city, or a zone, the “location” column specifies the identifier for a logical model, while the “logical model” column specifies the name of the location associated with the logical model. By selecting from the corresponding options of view, delete, and update in the “operation” column, a system user instructs the computer program 106 to enable the user a system user instructs the computer program 106 to edit the corresponding logical model, to delete the corresponding logical model, or to export the corresponding logical model.

Once a user associates a logical model to a location or a collection of locations, the computer program 106 will traverse the tags for the logical model, and determine algorithmically which calculations need to be performed and what data will be persisted. Theses aggregates are then persisted in the Energy Management System's database for later retrieval. By using the logical models as drivers for the calculations, the computer program 106 separates the core calculation code from the complex, and somewhat arbitrary nature of the physical model, and limits the calculations to the tags for the dynamically created logical models. For example, the calculations necessary to represent both logical models depicted in FIG. 3 will be executed and persisted. However, if the parking garage's logical model is removed from the system 100, the calculations for the parking garage's logical model will be eliminated, thus reducing unnecessary calculations. The physical configuration for the parking garage's logical model is left intact within the system 100. If at a later date, a user desires to view the physical assets of Facility 5, the parking garage, in a different way, they can quickly create a new logical model and subscribe Facility 5 to it. In a traditional Energy Management System, the user may have had to completely remove the physical installation of Facility 5 from the traditional Energy Management System.

Because the frames 200-300 in FIG. 2-FIG. 3, respectively, are samples, the frames 200-300 could vary greatly in appearance. For example, the relative sizes and positioning of the columns and rows are not important to the practice of the present disclosure. The frames 200-300 can be depicted by any visual display, but are preferably depicted by a computer screen. The frames 200-300 could also be output as reports and printed or saved in electronic format, such as portable document file (PDF). The frames 200-300 can be part of a personal computer system and/or a network, and operated from system data received locally, by the network, and/or on the Internet. The frames 200-300 may be navigable by a user. Typically, a user can employ a touch screen input or a mouse input device to point-and-click to a location on the frames 200-400 to manage the text on the frames 200-300, such as a selection that enables a user to drag the text from at least some of the columns 202-210 and drop the text into the reformatted variables column 212. Alternately, a user can employ directional indicators, or other input devices such as a keyboard. The text depicted by the frames 200-300 are examples, as the frames 200-300 may include a much greater amount of text.

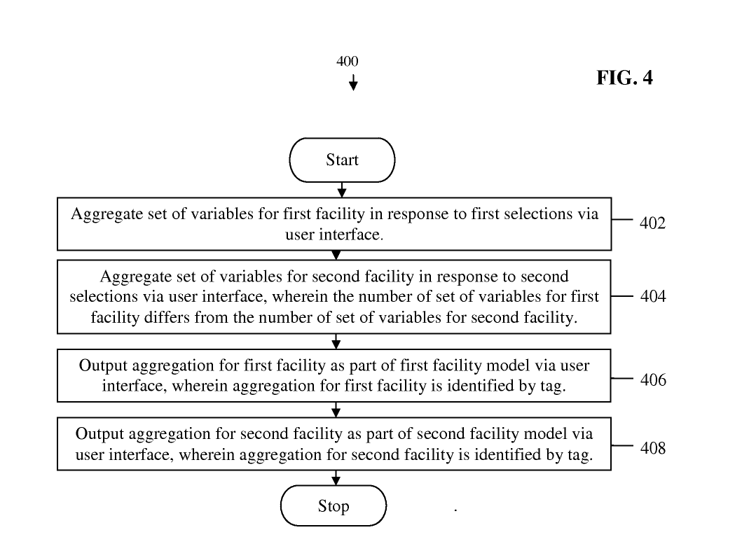

FIG. 4 presents a sample method 400 of the present disclosure. The energy management system 100 in FIG. 1 may execute the method 400 to aggregate different numbers of variables in different facilities to the same tags that are output as parts of logical models.

In box 402, a set of variables for a first facility is aggregated in response to first selections via a user interface. For example, the computer program 106 aggregates the user- selected set of variables for the first facility and identifies the aggregation as HVAC totals for facility 1.

In box 404, a set of variables for a second facility is aggregated in response to second selections via a user interface, wherein the number of the set of variables for the first facility differs from the number of the set of variables for the second facility. For example, the computer program 106 aggregates the user-selected set of variables for the second facility and identifies the aggregation as HVAC totals for facility 2. The five HVAC variables for first facility differ in number from the two HVAC variables for second facility.

In box 406, an aggregate for a first facility is output as part of a first facility model via a user interface, wherein the aggregate for the first facility is identified by a tag. For example, the computer program 106 outputs the HVAC aggregate for the first facility as part of the first facility model, wherein the HVAC aggregate for first facility is identified by the “HVAC” tag.

In box 408, an aggregate for a second facility is output as part of a second facility model via a user interface, wherein the aggregate for the second facility is identified by a tag. For example, the computer program 106 outputs the HVAC aggregate for the second facility as part of the second facility model, wherein the HVAC aggregate for the second facility is also identified by the “HVAC” tag.

The method 400 may be repeated as desired. Although this disclosure describes the boxes 402-408 executing in a particular order, the boxes 402-408 may be executed in a different order.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

The following are incorporated herein by reference for all purposes: U.S. patent application Ser. No. 13/155,222, to Burke, filed Jun. 7, 2011; U.S. patent application Ser. No. 13/219,361, to Burke, filed Aug. 26, 2011; U.S. patent application Ser. No. 13/155,222, to Burke, filed Jun. 7, 2011; U.S. patent application Ser. No. 13/219,361, to Burke, filed Aug. 26, 2011; US Patent Application entitled “Dynamic Tagging to Create Logical Models and Optimize Caching In Energy Management Systems” to Burke concurrently herewith; and US Patent Application entitled “Load Profile Management and Cost Sensitivity Analysis”, to Burke filed concurrently herewith.

1. A system for dynamic tagging to create logical models and optimize caching in energy management systems, the system including:
a computer;
a memory;
a user interface; and
a computer program stored in the memory and executable by the computer to:
aggregate a set of variables for a first facility in response to first selections via the user interface;
aggregate a set of variables for a second facility in response to second selections via the user interface, wherein the number of the set of variables for the first facility differs from the number of the set of variables for the second facility;
output the aggregation for the first facility as part of a first facility model via the user interface, wherein the aggregation for the first facility is identified by a tag; and
output the aggregation for the second facility as part of a second facility model via the user interface, wherein the aggregation for the second facility is identified by the tag.

2. A system as in claim 1, wherein the set of variables for the first facility is associated with a set of facility equipment.

3. A system as in claim 1, wherein the set of variables for the second facility is associated with a set of facility equipment.

4. A system as in claim 1, wherein the first facility model comprises a plurality of tags.

5. A system as in claim 1, wherein the second facility model comprises a plurality of tags.

6. A system as in claim 1, wherein the tag identifies an associated facility.

7. A system as in claim 1, further comprising storing a subscription for an aggregation of the set of variables for the first facility in a facility model library in response to the first selections via the user interface.

8. A system as in claim 1, further comprising storing a subscription for the aggregation of the set of variables for the second facility in a facility model library in response to the second selections via the user interface.

9. A computer-implemented method for dynamic tagging to create logical models and optimize caching in energy management systems, the method including the steps of:
identifying, by a computer program stored in a memory and executed by a computer, subscriptions in a facility model library, wherein the subscriptions comprise a subscription for an aggregation of a set of variables for a first facility and a subscription for an aggregation of a set of variables for a second facility, wherein the number of the set of variables for the first facility differs from the number of the set of variables for the second facility;
aggregating, by the computer program, the set of variables for the first facility;
aggregating, by the computer program, the set of variables for the second facility;
outputting, by the computer program, the aggregation for the first facility as part of a first facility model via the user interface, wherein the aggregation for the first facility is identified by a tag; and
outputting, by the computer program, the aggregation for the second facility as part of a second facility model via the user interface, wherein the aggregation for the second facility is identified by the tag.

10. A computer-implemented method as in claim 9, wherein the set of variables for the first facility is associated with a set of facility equipment.

11. A computer-implemented method as in claim 9, wherein the set of variables for the second facility is associated with a set of facility equipment.

12. A computer-implemented method as in claim 9, wherein the first facility model comprises a plurality of tags.

13. A computer-implemented method as in claim 9, wherein the second facility model comprises a plurality of tags.

14. A computer-implemented method as in claim 9, wherein the tag identifies an associated facility

15. A computer program product for dynamic tagging to create logical models and caching in energy management systems, the computer program product including:
a computer readable storage medium storing computer executable program code that, when executed by a processor, causes the computer executable program code to perform a method including the steps of:
aggregating a first set of variables in response to first selections via a user interface;
aggregating a second set of variables in response to second selections via the user interface, wherein the first set of variables shares at least one variable with the second set of variables;
output the aggregation of the first set of variables as part of a first facility model via the user interface, wherein the aggregation for the first facility is identified by a first tag; and
output the aggregation for the second set of variables as part of a second facility model via the user interface, wherein the aggregation for the second facility is identified by a second tag.

16. A computer program product as in claim 15, wherein the first set of variables is associated with a set of facility equipment.

17. A computer program product as in claim 15, wherein the second set of variables is associated with a set of facility equipment.

18. A computer program product as in claim 15, wherein the first facility model comprises a plurality of tags.

19. A computer program product as in claim 15, wherein the second facility model comprises a plurality of tags.

20. A computer program product as in claim 15, further comprising storing a subscription for the aggregation of the first set of variables and a subscription for the aggregation of the second set of variables in a facility model library in response to the first selections and the second selections, respectively, via the user interface.
